(19) United States
(12) Patent Application Publication
(10) Pub. No.: US 2008/0225675 A1
(43) Pub. Date: Sep. 18, 2008

(54) Optical disk apparatus

(75) Inventors: Ryoichi Kawasaki, Isesaki-Shi (JP); Shinsei Kasahara, Sagamihara-Shi (JP)

Correspondence Address: MCDERMOTT WILL & EMERY LLP, 600 13TH STREET, N.W., WASHINGTON, DC, 20005-3096, US

(73) Assignees: SANYO ELECTRIC CO., LTD; SANYO OPTEC DESIGN CO., LTD.

(21) Appl. No.: 11/984,642

(22) Filed: Nov. 20, 2007

(30) Foreign Application Priority Data
Mar. 14, 2007 (JP) 2007-065335

(51) Int. Cl. G11B 7/00

(52) U.S. Cl. 369/121

(57) ABSTRACT

An optical disk apparatus includes: a semiconductor laser which emits laser light; a focusing unit which focuses the laser light emitted from the semiconductor laser onto an optical disk; a detector which receives reflected light from the optical disk; a drive unit which rotates the optical disk; and a control unit which controls the semiconductor laser and the drive unit. When the optical disk is reproduced, the control unit causes the semiconductor laser to emit the laser light by a first power realizing a relative intensity noise tolerable for the reproduction of the optical disk. And the control unit causes the drive unit to rotate the optical disk at a first linear velocity which is free from reproduction light deterioration when the semiconductor laser emits the laser light by the first power.

### CROSS-REFERENCE TO RELATED APPLICATIONS

This application is based upon and claims the benefit of priority from the prior Japanese Patent Application No. 2007-065335, filed on Mar. 14, 2007, the entire contents of which are incorporated herein by reference.

### BACKGROUND OF THE INVENTION

1. Field of the Invention

The present invention relates to an optical disk apparatus having a function of reproducing information recorded on an optical disk, and it particularly relates to an optical disk apparatus using a blue-violet-emitting semiconductor laser.

2. Description of the Related Art

In recent years, an optical disk apparatus using a semiconductor laser that emits blue-violet light whose wavelength is 405 nm is put to practical use. With this blue-violet-emitting semiconductor laser, the laser light can be narrowed down so as to be irradiated to a smaller spot of an optical disk. Thus, the recording density of the optical disk can be raised as compared with a conventional optical disk using semiconductor laser whose wavelength is 660 nm, so that a recording capacity thereof can be raised.

When the optical power of the blue-violet-emitting semiconductor laser is lowered, a relative intensity noise (RIN) becomes extremely large. This is a typical characteristic of the blue-violet-emitting semiconductor laser. Thus, it is required that the optical power at the time of reproduction of recorded data be set to a certain high level in the optical disk apparatus using the blue-violet-emitting semiconductor laser. However, the raised optical power causes a problem of reproduction light deterioration including a degradation of the optical disk, data erasure and the like.

### SUMMARY OF THE INVENTION

One embodiment of the present invention comprises: a semiconductor laser which emits laser light; a focusing unit which focuses the laser light emitted from the semiconductor laser onto an optical disk; a detector which receives reflected light from the optical disk; a drive unit which rotates the optical disk; and a control unit which controls the semiconductor laser and the drive unit. When the optical disk is reproduced, the control unit causes the semiconductor laser to emit the laser light at a first power that realizes a relative intensity noise tolerable for the reproduction of the optical disk; and the control unit causes the drive unit to rotate the optical disk at a first linear velocity which is free from reproduction light deterioration when the semiconductor laser emits the laser light at the first power.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 illustrates a structure of an optical disk apparatus according to an embodiment of the present invention; and

FIG. 2 illustrates an example of relations between power and relative intensity noise of a semiconductor laser according to an embodiment of the present invention.

### DETAILED DESCRIPTION OF THE INVENTION

The invention will now be described by reference to the preferred embodiments. This does not intend to limit the scope of the present invention, but to exemplify the invention.

Firstly, a description of a representative embodiment will be given before describing preferred embodiments of the present invention. An optical disk apparatus according to one embodiment of the present invention comprises: a semiconductor laser which emits laser light; a focusing unit which focuses the laser light emitted from the semiconductor laser onto an optical disk; a detector which receives reflected light from the optical disk; a drive unit which rotates the optical disk; and a control unit which controls the semiconductor laser and the drive unit. When the optical disk is reproduced, the control unit causes the semiconductor laser to emit the laser light at a first power that realizes a relative intensity noise tolerable for the reproduction of the optical disk; and the control unit causes the drive unit to rotate the optical disk at a first linear velocity which is free from reproduction light deterioration when the semiconductor laser emits the laser light at the first power.

By employing this embodiment, the relative intensity noise of the semiconductor laser is suppressed to a low noise level and thereby excellent reproducing characteristics are achieved. At the same time the reproduction light degradation can be prevented. Also, a mechanism for moving an intensity filter into or out of a light path of the laser light and the like mechanism are no longer necessary. Instead, the equivalent mechanism can be achieved by varying the linear velocity alone, so that the optical disk apparatus can be manufactured at low cost.

The optical disk apparatus may further comprise a first storage which stores a relation between power of the semiconductor laser and the relative intensity noise as a first relation, and the control unit may set the first power by referring to the first relation. The optical disk apparatus may further comprise a second storage which stores, as a second relation, a relation between the power of the semiconductor laser and a minimum linear velocity at which no reproduction light deterioration is caused; and the control unit may set the first linear velocity by referring to the second relation. In such cases, the first power and the first linear velocity can be suitably set.

When the first linear velocity is not realized due to an upper limit of rotational angular velocity of the optical disk, the control unit may set a second linear velocity which is less than or equal to a linear velocity at the upper limit of rotational angular velocity thereof, and emit the semiconductor laser at a second power which is free from reproduction light deterioration.

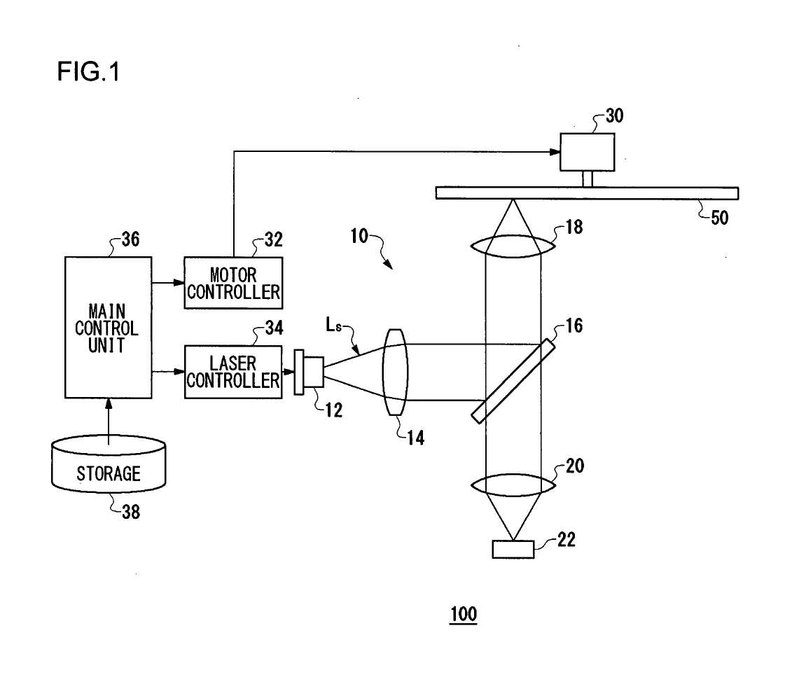

FIG. 1 illustrates a structure of an optical disk apparatus 100 according to an embodiment of the present invention. FIG. 1 illustrates components related to a reproduction function among functions of the optical disk apparatus. In terms of hardware, each block shown in FIG. 1 can be realized by elements or mechanical devices such as a CPU or memory of a computer. In terms of software, it can be realized by computer programs and the like, but drawn and described herein are function blocks that are realized in cooperation with those. Hence, it is understood by those skilled in the art that these function blocks can be realized in a variety of forms by a combination of hardware and software.

As shown in FIG. 1, an optical disk apparatus 100 includes an optical pickup device 10, a laser controller 34 which controls current applied to a semiconductor laser 12 of the optical pickup device 10, a spindle motor 30 which rotates the optical disk 50, a motor controller 32 which controls current applied to the spindle motor 30, a main control unit 36 which issues instructions to the laser controller 34, and a storage 38. Though not shown in FIG. 1, the optical disk apparatus 100 also includes components by which to vary the position of the optical pickup device 10 relative to the optical disk 50.

The optical pickup device 10 includes a semiconductor laser 12, a collimating lens 14, a beam splitter 16, an objective lens 18, a collective lens 20, and an photodiode 22. A GaN type blue-violet-emitting semiconductor laser whose wavelength is 405 nm is used as the semiconductor laser 12. The semiconductor laser 12 outputs a laser light Ls of power P according to an impressed current from the laser controller 34.

The collimating lens 14, the beam splitter 16 and the objective lens 18 function as a focusing unit for focusing the laser light Ls outputted from the semiconductor laser 12, onto the optical disk 50. The collimating lens 14 converts the laser light Ls from the semiconductor laser 12, into parallel light. The beam splitter 16 reflects the incoming parallel light from the collimating lens 14 in the direction toward the objective lens 18, and has the light from the objective lens 18 transmitted in the direction of the collective lens 20. The objective lens 18 focuses the light from the beam splitter 16 onto the optical disk 50. The collective lens 20 focuses the light from the beam splitter 16 onto the photodiode 22. The photodiode 22 receives the light from the collective lens 20 and then converts the received light into electric signals. In this manner, the photodiode 22 functions as a detector for receiving the reflected light from the optical disk 50.

When reproducing the optical disk 50, the semiconductor laser 12 in the optical disk apparatus 100 according to the present embodiment emits the laser light Ls at a power Pr that realizes a relative intensity noise tolerable for the reproduction of the optical disk 50. At this time, the spindle motor 30 rotates the optical disk 50 at a linear velocity Vr which is free from reproduction light deterioration when the semiconductor laser 12 emits the laser light at the power Pr.

In general, a recording mark is formed, on a fine region irradiated with the laser light, by the thermal energy of the laser light irradiated to a disk surface. For example, in the case of a phase-change type optical disk, only a region irradiated with the laser light melts once and then solidifies again. As a result, a structure transits from a crystalline structure to an amorphous structure so as to form the recording mark. Here, in order to perform high-speed recording by rotating the optical disk at high speed, the recording mark needs to be formed in a shorter period of time. Thus, the power of the laser light irradiated to a recording layer must be raised.

The inventors of the present invention focused attention on a relation between the linear velocity of the above-described optical disk and the power of the laser light required for the recording, and came to recognize the core part of the present invention as follows. That is, even if the power P of the semiconductor layer 12 at reproduction is raised to the power Pr that realizes the relative intensity noise tolerable for the reproduction of the optical disk, it is speculated that no change will result in the recording layer if the optical disk is rotated at higher speed and consequently the reproduction light degradation can be prevented.

In a technique for reproducing information recorded on optical disks, it is known that an excellent reproducing characteristics are obtained if the relative intensity noise of the semiconductor laser is set to −125 dB/Hz or below. Thus it is preferred that the power Pr realizing the relative intensity noise tolerable for the reproduction of the optical disk be set to a power such that the relative intensity noise of the semiconductor laser 12 becomes −125 dB/Hz or below.

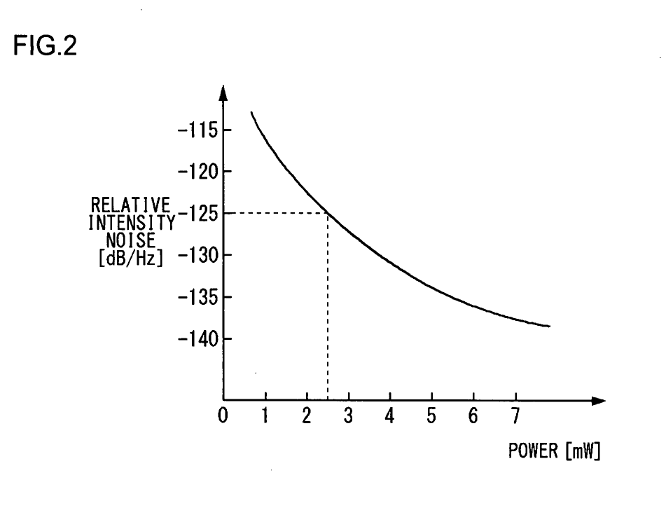

FIG. 2 illustrates an example of relations between the power and the relative intensity noise of a semiconductor laser. As shown in FIG. 2, the relative intensity noise tends to be smaller as the power becomes larger. By referring to such a relation Rpr between the power and the relative intensity noise of the semiconductor laser, the power Pr of the semiconductor laser 12 can be set where the relative noise intensity is −125 dB/Hz or below. In the case of the example depicted in FIG. 2, it is preferred that the power Pr be set to a predetermined power greater than or equal to 2.5 mW.

The linear velocity Vr at which no reproduction light degradation occurs can be determined experimentally or through simulation as appropriate.

For example, the semiconductor laser is emitted at a level of power P, and while the jitter of the output of the photodiode 22 is being monitored by a jitter monitor, the linear velocity V of the optical disk 50 is increased gradually. If the linear velocity V is low, the reproduction light degradation will occur, thereby causing the output of the photodiode 22 to jitter much. However, when the linear velocity becomes a prescribed linear velocity Vrmin or above, the reproduction light degradation no longer takes place and the jitter becomes small. This linear velocity Vrmin at which the reproduction light degradation no longer occurs is called a “minimum linear velocity Vrmin”.

A relation Rpv between the power P of the semiconductor laser 12 and the minimum linear velocity Vrmin is acquired in a manner that the power P of the semiconductor laser 12 is varied and the minimum linear velocities for the respective powers P are measured. A minimum linear velocity Vrmin at a predetermined power Pr can be obtained by referring to this relation Rpv.

Accordingly, if the optical disk 50 is rotated at a linear velocity Vr which is greater or equal to its minimum linear velocity Vrmin, no reproduction light degradation will occur.

The storage 38 stores the relation Rpv, obtained as above, between the power P and the minimum linear velocity Vrmin and the relation, as shown in FIG. 2, between the power P and the relative intensity noise. In the present embodiment, the storage 38 functions as the first storage for storing the relation Rpr and the second storage for storing the relation Rpv. It is preferable that the relation Rpv and the relation Rpr be measured beforehand and stored in the storage 38. For example, when the optical disk apparatuses 100 are to be manufactured in a plant, the relations may be measured per optical disk apparatus 100. In such a case, the relation Rpv and the relation Rpr can be acquired with accuracy. Also, the relation Rpv and the relation Rpr on a single optical disk apparatus 100 may be measured per lot, and the same relations Rpv and Ppr may be stored for the same lot. In this case, the number of manufacturing process steps can be reduced. That is, the manufacturing process can be simplified.

The main control unit 36 controls the power P and the linear velocity V of the semiconductor laser 12, based on the relation Rpv and the relation Rpr stored in the storage 38. That is, when an instruction to reproduce the optical disk 50 is given, the main control unit 36 first refers to the relation Rpr and then sets the power Pr of the semiconductor laser 12 at which the relative intensity noise is less than or equal to −125 dB/Hz. Then the main control unit 36 obtains the minimum linear velocity Vrmin for the power Pr which has been set, by referring to the relation Rpv, and sets a linear velocity Vr which is greater than or equal to its minimum linear velocity Vrmin. Then the main control unit 36 gives instructions to the motor controller 32 and the laser controller 34 so that the power P of the semiconductor laser 12 becomes the power Pr and the linear velocity V of the optical disk 50 becomes the linear velocity Vr. Thereby, the laser Ls is irradiated at the power Pr that realizes a relative intensity noise tolerable for the reproduction. Also, the optical disk 50 is rotated at the linear velocity Vr which is free from the reproduction light degradation when the semiconductor laser 12 is irradiated at said power Pr. As a result, the relative intensity noise of the semiconductor laser 12 can be suppressed to a low level so as to achieve excellent reproduction characteristics and, at the same time, the reproduction light degradation can be prevented.

An operation of the optical disk apparatus 100 structured as above is now described. When an instruction to reproduce the optical disk 50 is given, the main control unit 36 sets the power Pr and the linear velocity Vr as described above and then gives instructions to the motor controller 32 and the laser controller 34.

The laser controller 34 applies the current to the semiconductor laser 12 so that the power P of the semiconductor 12 will become the power Pr instructed by the main control unit 36. The laser light Ls that has emitted from the semiconductor laser 12 Ls is converted into parallel light by the collimating lens 14. After this parallel light is reflected by the beam splitter 16, the parallel light is focused onto the disk surface of the optical disk 50 by the objective lens 18.

The motor controller 32 applies the current to the spindle motor 30 so that the linear velocity V of the optical disk 50 will be the linear velocity Vr specified by the main control unit 36. After having transmitted through the objective lens 18 and the beam splitter 16, the signal light reflected by the optical disk 50 is focused onto the photodiode 22 by the collective lens 20 where it is converted into electric signals and information recorded on the optical disk 50 is reproduced.

As described above, by employing the optical disk apparatus 100 according to the present embodiment, when the optical disk 50 is reproduced, the laser light is irradiated to the semiconductor laser 12 using the power Pr by which to achieve a relative intensity noise tolerable for the reproduction, and the optical disk 50 is rotated at the linear velocity Vr which is free from reproduction light deterioration when the semiconductor laser 12 emits the laser light at the power Pr. As a result, the relative intensity noise of the semiconductor laser 12 can be suppressed to a low level so as to achieve excellent reproduction characteristics and, at the same time, the reproduction light degradation can be prevented. Also, a mechanism for moving an intensity filter into or out of a light path of the laser light and the like mechanism are no longer necessary. Instead, the equivalent mechanism can be achieved by varying the linear velocity alone, so that the optical disk apparatus 100 can be manufactured at low cost.

The present invention has been described based on a preferred embodiment. This preferred embodiment is merely exemplary, and it is understood by those skilled in the art that various modifications to the combination of each component and process thereof are possible and that such modifications are also within the scope of the present invention.

For example, in the above embodiment, the blue-violet-emitting semiconductor laser is used as a semiconductor laser. However, this should not be considered as limiting and, for example, a red-emitting semiconductor laser or those with other ranges of wavelengths may be used.

As for the optical system of the optical pickup device, various optical systems other than that exemplified by FIG. 1 are also available. Since the present embodiment can be achieved by controlling the power of the laser light and the linear velocity of the optical disk, the present embodiment can be applied to any type of optical systems.

In the above-described embodiment, the laser light is irradiated at the power Pr where a relative intensity noise tolerable for the reproduction is achieved, and the optical disk 50 is rotated at the linear velocity Vr which is free from reproduction light deterioration when the semiconductor laser 12 emits the laser light at the power Pr. Since in an rotational angular velocity ω of the optical disk 50 there is an upper limit ωmax of rotational angular velocity thereof, there are cases where a desired linear velocity cannot be realized. The linear velocity of the optical disk 50 is proportional to the distance from the center of a disk. Thus there are cases where it is difficult to realize a desired linear velocity Vr particularly in an inner circumference side. In such a case, the main control unit 36 sets a linear velocity Vr1 which is achievable in practice, and causes the semiconductor laser 12 to emit the light at a power Pr1 which is free from reproduction light deterioration at this linear velocity Vr1. Though the linear velocity Vr1 will be a linear velocity less than or equal to the linear velocity Vmax in the case of the rotational angular velocity ωmax, it is preferably as close a value as possible to the Vmax. If a control is performed in this manner, the characterization of the relative intensity noise will be deteriorated in some degree but the occurrence of the reproduction light degradation can be prevented.

While the preferred embodiments of the present invention and modifications thereof have been described using specific terms, such description is for illustrative purposes only, and it is to be understood that changes and variations may be further made without departing from the spirit or scope of the appended claims.

What is claimed is:

1. An optical disk apparatus, comprising:
a semiconductor laser which emits laser light;
a focusing unit which focuses the laser light emitted from said semiconductor laser onto an optical disk;
a detector which receives reflected light from the optical disk;
a drive unit which rotates the optical disk; and
a control unit which controls said semiconductor laser and said drive unit,
wherein when the optical disk is reproduced, said control unit causes said semiconductor laser to emit the laser light at a first power realizing a relative intensity noise tolerable for the reproduction of the optical disk, and
wherein said control unit causes said drive unit to rotate the optical disk at a first linear velocity which is free from reproduction light deterioration when said semiconductor laser emits the laser light at the first power.

2. An optical disk apparatus according to claim 1, further comprising a first storage which stores a relation between power of said semiconductor laser and the relative intensity noise as a first relation,
wherein said control unit sets the first power by referring to the first relation.

3. An optical disk apparatus according to claim 2, further comprising a second storage which stores, as a second relation, a relation between the power of said semiconductor laser and a minimum linear velocity at which no reproduction light deterioration is caused,
wherein said control unit sets the first linear velocity by referring to the second relation.

4. An optical disk apparatus according to claim 1, wherein when the first linear velocity is not realized due to an upper limit of rotational angular velocity of the optical disk, said control unit sets a second linear velocity which is less than or equal to a linear velocity at the upper limit of rotational angular velocity thereof, and emits the semiconductor laser at a second power which is free from reproduction light deterioration.

5. An optical power according to claim 1, wherein the first power is set in a manner such that the relative intensity noise of said semiconductor laser is less than or equal to −125 dB/Hz.

6. An optical disk apparatus according to claim 1, wherein said semiconductor laser is a laser that emits light in a wavelength range of blue-violet color.
